(19) United States
(12) Patent Application Publication
(10) Pub. No.: US 2025/0279451 A1
(43) Pub. Date: Sep. 4, 2025

(54) FUEL CELL SYSTEM

(71) Applicant: TOYOTA JIDOSHA KABUSHIKI KAISHA, Toyota-shi (JP)

(72) Inventors: Ikuyasu KATO, Obu-shi (JP); Kazuhiko KOHARI, Sunto-gun (JP); Yoshihiro SHINOZAKI, Atsugi-shi (JP); Norio YAMAGISHI, Mishima-shi (JP)

(21) Appl. No.: 19/063,836

(22) Filed: Feb. 26, 2025

(30) Foreign Application Priority Data
Mar. 1, 2024 (JP) 2024-031141

(51) Int. Cl. H01M 8/04746; H01M 8/04228; H01M 8/04303; H01M 8/0432; H01M 8/0438; H01M 8/04537; H01M 8/10; H01M 8/1004

(52) U.S. Cl. CPC H01M 8/04753; H01M 8/04228; H01M 8/04303; H01M 8/0432; H01M 8/04395; H01M 8/04634; H01M 8/1004; H01M 2008/1095

(57) ABSTRACT

A fuel cell system includes: a fuel cell stack that generates electric power by using a chemical reaction of anode gas and cathode gas; a temperature measurement section that measures temperature of the fuel cell stack; a depressurization section; and an operation control section that controls the fuel cell stack and the depressurization section. The fuel cell stack includes a cathode gas channel in which the cathode gas flows. The depressurization section allows the cathode gas channel to be depressurized. When the operation control section stops the operation of the fuel cell stack, the operation control section controls the depressurization section to cause the depressurization section to depressurize the inside of the cathode gas channel until pressure inside the cathode gas channel falls below the saturated water vapor pressure corresponding to the temperature of the fuel cell stack measured by the temperature measurement section.

### CROSS-REFERENCE TO RELATED APPLICATION

This application claims priority to Japanese Patent Application No. 2024-031141 filed on Mar. 1, 2024, incorporated herein by reference in its entirety.

### BACKGROUND

### 1. Technical Field

The present disclosure relates to a fuel cell system.

### 2. Description of Related Art

For example, Japanese Unexamined Patent Application Publication No. 2008-97993 (JP 2008-97993 A) discloses a fuel cell system that removes residual water inside a cathode gas channel by communicating the cathode gas channel with a depressurization section depressurized to pressure lower than the atmospheric pressure when a fuel cell stack is stopped.

### SUMMARY

JP 2008-97993 A studies a fuel cell system that allows residual water inside a fuel cell stack to be efficiently removed so that it is not frozen even when used under a low-temperature environment, but studies nothing about an increase in the durability of the fuel cell system.

It is possible to implement the present disclosure as the following aspects.
(1) According to an aspect of the present disclosure, a fuel cell system is provided. The fuel cell system includes: a fuel cell stack configured to generate electric power by using a chemical reaction of anode gas and cathode gas; a temperature measurement section configured to measure the temperature of the fuel cell stack; a depressurization section; and an operation control section configured to control the fuel cell stack and the depressurization section. The fuel cell stack includes a cathode gas channel in which the cathode gas flows. The depressurization section is configured to allow the cathode gas channel to be depressurized. The operation control section is configured to, in a case where the operation control section stops the operation of the fuel cell stack, control the depressurization section to cause the depressurization section to depressurize the inside of the cathode gas channel until the pressure of the inside of the cathode gas channel falls below the saturated water vapor pressure corresponding to the temperature of the fuel cell stack measured by the temperature measurement section.

The fuel cell system according to the aspect makes it possible to decrease the amount of moisture included in a membrane electrode assembly included in the fuel cell stack. It is therefore possible to reduce the deterioration of a cathode catalyst layer included in the membrane electrode assembly and increase the durability of the fuel cell system.
(2) The fuel cell system according to the aspect may include: a pressure measurement section configured to measure the pressure of the inside of the cathode gas channel; and a target pressure setting section configured to set depressurization target pressure that is the pressure of the inside of the cathode gas channel depressurized by the depressurization section. The target pressure setting section may be configured to set the pressure less than the saturated water vapor pressure as the depressurization target pressure. The operation control section may be configured to, in the case where the operation control section stops the operation of the fuel cell stack, control the depressurization section to cause the depressurization section to depressurize the inside of the cathode gas channel until the pressure measured by the pressure measurement section reaches the depressurization target pressure.

The fuel cell system according to the aspect makes it possible to control an operation of depressurizing the cathode gas channel by using the pressure of the inside of the cathode gas channel as an indicator.
(3) In the fuel cell system according to the aspect, the target pressure setting section may be configured to set, as the depressurization target pressure, a value of 25% or more of the saturated water vapor pressure and less than 80% of the saturated water vapor pressure.

The fuel cell system according to the aspect makes it possible to decrease the amount of moisture included in the membrane electrode assembly included in the fuel cell stack and restrain the membrane electrode assembly from being dried too much by the depressurization.
(4) The fuel cell system according to the aspect may further include a stack case in which the fuel cell stack is stored. The depressurization section may be configured to allow the inside of the stack case to be depressurized. The operation control section may be configured to, in the case where the operation control section stops the operation of the fuel cell stack, control the depressurization section to cause the depressurization section to depressurize the inside of the stack case.

The fuel cell system according to the aspect makes it possible to keep the fuel cell stack warm by insulating the fuel cell stack. It is therefore possible to efficiently depressurize the inside of the cathode gas channel.
(5) The fuel cell system according to the aspect may include: a pressure measurement section configured to measure the pressure of the inside of the cathode gas channel; a membrane resistance measurement section configured to measure membrane resistance that is the electric resistance of a membrane electrode assembly included in the fuel cell stack; and a driving time setting section configured to set the driving time of the depressurization section. The driving time setting section may be configured to set driving scheduled time by using the membrane resistance measured by the membrane resistance measurement section. The driving scheduled time is the driving time necessary to increase a value of the membrane resistance to a predefined target resistance value. The operation control section may be configured to, in the case where the operation control section stops the operation of the fuel cell stack, control the depressurization section to cause the depressurization section to depressurize the inside of the cathode gas channel until the driving scheduled time elapses after the pressure measured by the pressure measurement section falls below the saturated water vapor pressure.

The fuel cell system according to the aspect makes it possible to control the operation of depressurizing the cathode gas channel by using the driving time of the depressurization section as an indicator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a schematic configuration of a fuel cell system;

FIG. 2 is a sectional view of a schematic configuration of a fuel cell;

FIG. 3 is a flowchart of operation stop processing according to a first embodiment;

FIG. 4 is a state diagram of water;

FIG. 5 is a diagram illustrating a relationship between pressure of an inside of a cathode gas channel, membrane resistance, and an oxidation amount of catalyst-supporting carbon;

FIG. 6 is an explanatory diagram illustrating a schematic configuration of a fuel cell system according to a second embodiment;

FIG. 7 is a flowchart of operation stop processing according to the second embodiment;

FIG. 8 is an explanatory diagram illustrating a schematic configuration of a fuel cell system according to a third embodiment;

FIG. 9 is a flowchart of operation stop processing according to the third embodiment;

FIG. 10 is a flowchart of the operation stop processing according to the third embodiment; and

FIG. 11 is a diagram describing driving time of a depressurization section and a change in the membrane resistance.

### DETAILED DESCRIPTION OF EMBODIMENTS

### A. First Embodiment

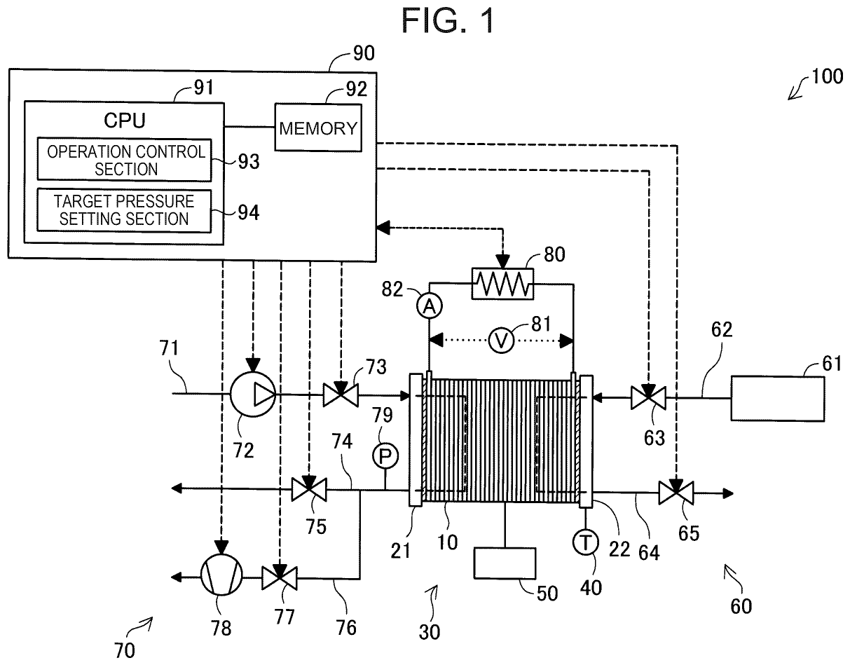

FIG. 1 is an explanatory diagram illustrating a schematic configuration of a fuel cell system 100. The fuel cell system 100 is mounted, for example, on a fuel cell electric vehicle (FCEV). The fuel cell system 100 includes a fuel cell stack 30, a temperature measurement section 40, a membrane resistance measurement section 50, an anode gas supply and discharge system 60, a cathode gas supply and discharge system 70, a load 80, and a control section 90.

The fuel cell stack 30 includes a plurality of fuel cells 10 and a pair of end terminals 21, 22. The fuel cells 10 each have a plate shape and are stacked in a stack direction that is the thickness direction of the fuel cells 10. The fuel cells 10 are electric power generation elements each capable of generating electric power even alone. In the present embodiment, each of the fuel cells 10 is configured as a polymer electrolyte fuel cell. The fuel cell 10 is supplied with anode gas and cathode gas serving as reactant gases and generates electric power by using an electrochemical reaction of the gases. For example, the anode gas is hydrogen and the cathode gas is air. The anode gas is also referred to as fuel gas and the cathode gas is also referred to as oxidant gas.

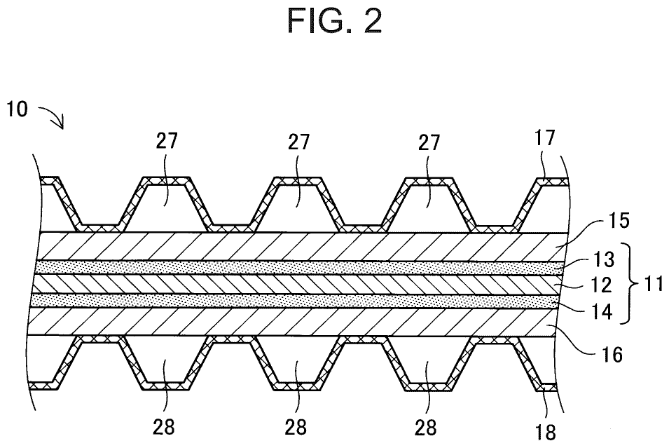

FIG. 2 is a sectional view of a schematic configuration of the fuel cell 10. The fuel cell 10 includes a membrane electrode assembly (MEA) 11, an anode diffusion layer 15, a cathode diffusion layer 16, an anode separator 17, and a cathode separator 18.

The membrane electrode assembly 11 includes an electrolyte membrane 12, an anode catalyst layer 13, and a cathode catalyst layer 14. The electrolyte membrane 12 is an ion-exchange membrane that is formed by using a polymer electrolyte material, for example, a fluorine-based resin including perfluorocarbon sulfonic acid, and has proton conductivity. The electrolyte membrane 12 exhibits favorable electric conductivity under a wet condition. The anode catalyst layer 13 and the cathode catalyst layer 14 are each formed by covering electrically conductive particles, for example, carbon particles, supporting a catalyst, such as platinum or a platinum alloy, with a polyelectrolyte having proton conductivity. The anode catalyst layer 13 is formed on one of the surfaces of the electrolyte membrane 12 and the cathode catalyst layer 14 is formed on the other surface of the electrolyte membrane 12.

The anode diffusion layer 15 and the cathode diffusion layer 16 each include, for example, a material having gas permeability and electric conductivity, such as carbon cloth or carbon paper. The anode diffusion layer 15 is formed on the surface of the anode catalyst layer 13 opposite to the surface of the anode catalyst layer 13 in contact with the electrolyte membrane 12. The cathode diffusion layer 16 is formed on the surface of the cathode catalyst layer 14 opposite to the surface of the cathode catalyst layer 14 in contact with the electrolyte membrane 12.

The anode separator 17 and the cathode separator 18 each include a member having gas barrier properties and electric conductivity. The anode separator 17 and the cathode separator 18 are each formed by using, for example, a carbon member, such as dense carbon, obtained by compressing carbon particles to not allow gas to permeate the carbon particles or a metal member, such as stainless steel or titanium steel, subjected to press molding. The anode separator 17 is disposed on the surface of the anode diffusion layer 15 opposite to the surface of the anode diffusion layer 15 in contact with the anode catalyst layer 13. The anode separator 17 includes an anode gas channel 27 in which anode gas flows. The cathode separator 18 is disposed on the surface of the cathode diffusion layer 16 opposite to the surface of the cathode diffusion layer 16 in contact with the cathode catalyst layer 14. The cathode separator 18 includes a cathode gas channel 28 in which cathode gas flows.

The end terminals 21, 22 illustrated in FIG. 1 are disposed at both end sections of the fuel cell stack 30 in the stack direction of the fuel cell stack 30. Specifically, the first end terminal 21 is disposed at one of the end sections of the fuel cell stack 30 and the second end terminal 22 is disposed at the other end section of the fuel cell stack 30. The first end terminal 21 is provided with openings connected to a cathode gas supply channel 71 and a cathode gas discharge channel 74 described below. The second end terminal 22 is provided with openings connected to an anode gas supply channel 62 and an anode gas discharge channel 64 described below.

The temperature measurement section 40 measures the temperature of the fuel cell stack 30. In the example illustrated in FIG. 1, the temperature measurement section 40 is connected to the second end terminal 22, but it is sufficient if the temperature measurement section 40 is disposed to allow the temperature of the fuel cell stack 30 to be measured. The temperature measurement section 40 is capable of transmitting the measured temperature to the control section 90.

The membrane resistance measurement section 50 measures membrane resistance that is the electric resistance of the membrane electrode assembly 11. In the example illustrated in FIG. 1, the membrane resistance measurement section 50 is connected to one of the fuel cells 10, but the membrane resistance measurement section 50 may be connected to each of the fuel cells 10. Alternatively, the membrane resistance measurement section 50 may be connected to allow the resistance value of the whole of the fuel cells 10 to be measured. The membrane resistance measurement section 50 is capable of transmitting the measured value of the membrane resistance to the control section 90.

The anode gas supply and discharge system 60 supplies anode gas to the fuel cell stack 30 and discharges anode off-gas from the fuel cell stack 30. The anode off-gas includes anode gas that is not used by the fuel cell stack 30 to generate electric power, moisture, and the like. The anode gas supply and discharge system 60 includes an anode gas tank 61, the anode gas supply channel 62, an anode gas inlet valve 63, the anode gas discharge channel 64, and an anode gas outlet valve 65.

The anode gas tank 61 is a container that stores anode gas to be supplied to the fuel cell stack 30. The anode gas tank 61 stores, for example, high-pressure hydrogen gas.

The anode gas supply channel 62 is a channel that leads anode gas to the fuel cell stack 30 from the anode gas tank 61. An end of the anode gas supply channel 62 is connected to the anode gas tank 61 and the other end of the anode gas supply channel 62 is connected to an opening of the second end terminal 22.

The anode gas inlet valve 63 adjusts the amount of anode gas to be supplied from the anode gas tank 61. The anode gas inlet valve 63 is provided to the anode gas supply channel 62.

The anode gas discharge channel 64 is a channel that discharges anode off-gas from the fuel cell stack 30. An end of the anode gas discharge channel 64 is connected to the opening of the second end terminal 22. The other end of the anode gas discharge channel 64 is open and anode off-gas is discharged through the opening.

The anode gas outlet valve 65 opens and closes the anode gas discharge channel 64. The anode gas outlet valve 65 is provided to the anode gas discharge channel 64.

The cathode gas supply and discharge system 70 supplies cathode gas to the fuel cell stack 30 and discharges cathode off-gas from the fuel cell stack 30. The cathode off-gas includes cathode gas that is not consumed by the fuel cell stack 30 to generate electric power, moisture that is generated in the electric power generation by the fuel cell stack 30, and the like. The cathode gas supply and discharge system 70 includes the cathode gas supply channel 71, an air pump 72, a cathode gas inlet valve 73, a cathode gas discharge channel 74, a cathode gas outlet valve 75, a cathode gas discharge branch channel 76, a cathode gas branch outlet valve 77, a depressurization section 78, and a pressure measurement section 79.

The cathode gas supply channel 71 is a channel that leads cathode gas to the fuel cell stack 30. An end of the cathode gas supply channel 71 is open. It is possible to take in cathode gas through the opening. The other end of the cathode gas supply channel 71 is connected to an opening of the first end terminal 21. The cathode gas supply channel 71 is provided with the air pump 72 and the cathode gas inlet valve 73.

The air pump 72 compresses cathode gas and supplies the cathode gas to the fuel cell stack 30 via the cathode gas supply channel 71.

The cathode gas inlet valve 73 adjusts the amount of cathode gas to be supplied from the air pump 72.

The cathode gas discharge channel 74 is a channel that discharges cathode off-gas from the fuel cell stack 30. An end of the cathode gas discharge channel 74 is connected to an opening of the first end terminal 21. The other end of the cathode gas discharge channel 74 is open and cathode off-gas is discharged through the opening.

The cathode gas outlet valve 75 opens and closes the cathode gas discharge channel 74. The cathode gas outlet valve 75 is provided to the cathode gas discharge channel 74.

The cathode gas discharge branch channel 76 is a channel branching from the cathode gas discharge channel 74 between the fuel cell stack 30 and the cathode gas outlet valve 75. An end section of the cathode gas discharge branch channel 76 is open.

The cathode gas branch outlet valve 77 opens and closes the cathode gas discharge branch channel 76. The cathode gas branch outlet valve 77 is provided to the cathode gas discharge branch channel 76. The cathode gas branch outlet valve 77 is closed while the fuel cell stack 30 is generating electric power.

The depressurization section 78 is provided to allow the cathode gas channels 28 inside the fuel cell stack 30, the cathode gas discharge channel 74, and the cathode gas discharge branch channel 76 to be depressurized. The depressurization section 78 is provided to the cathode gas discharge branch channel 76. The depressurization section 78 is, for example, a vacuum pump.

The pressure measurement section 79 measures the pressure of the inside of the cathode gas channel 28. The pressure measurement section 79 is provided to the cathode gas discharge channel 74 between the fuel cell stack 30 and the cathode gas outlet valve 75.

The load 80 is connected to the fuel cell stack 30 via an unillustrated electrical circuit including a DC/DC converter. The load 80 is, for example, a drive motor of a vehicle on which the fuel cell system 100 is mounted. The electrical circuit is provided with a voltage measurement section 81 and an electric current measurement section 82. The voltage measurement section 81 and the electric current measurement section 82 are capable of measuring an output voltage and an output electric current of the fuel cell stack 30 and transmitting the measurement values to the control section 90.

The control section 90 is configured as a computer including a CPU 91 and a memory 92. The CPU 91 reads out and executes control programs stored in the memory 92 to function as an operation control section 93 and a target pressure setting section 94.

The operation control section 93 controls the respective sections of the fuel cell system 100 to cause the fuel cell stack 30 to generate electric power. Specifically, the operation control section 93 controls the valves included in the anode gas supply and discharge system 60 and the cathode gas supply and discharge system 70, the air pump 72, and the depressurization section 78 to control the operation of the fuel cell stack 30.

The target pressure setting section 94 sets depressurization target pressure that is the pressure of the inside of the cathode gas channel 28 depressurized by the depressurization section 78.

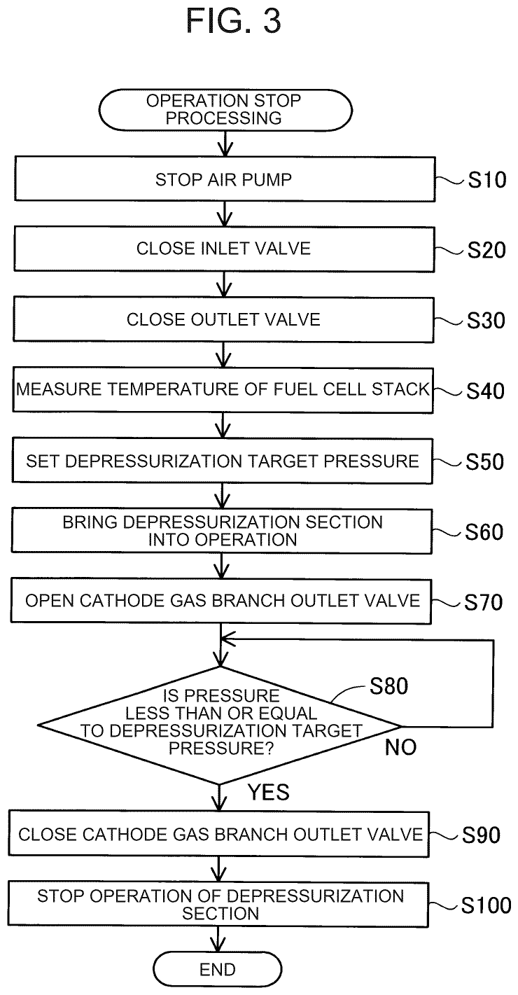

FIG. 3 is a flowchart of operation stop processing according to the first embodiment. The operation stop processing is processing of stopping the operation of the fuel cell stack 30. The operation stop processing is executed in a case where the control section 90 receives an operation stop signal. The operation stop signal is received, for example, in a case where a switch that starts the vehicle on which the fuel cell system 100 is mounted is turned off.

In step S10, the operation control section 93 stops the air pump 72.

In step S20, the operation control section 93 closes the anode gas inlet valve 63 and the cathode gas inlet valve 73.

In step S30, the operation control section 93 closes the anode gas outlet valve 65 and the cathode gas outlet valve 75. Step S20 and step S30 are executed to seal the anode gas channel 27 and the cathode gas channel 28.

In step S40, the temperature measurement section 40 measures the temperature of the fuel cell stack 30. The temperature of the fuel cell stack 30 measured here is temperature at the time of stopping the operation of the fuel cell stack 30.

In step S50, the target pressure setting section 94 sets the pressure less than the saturated water vapor pressure corresponding to the temperature of the fuel cell stack 30 measured in step S40 as the depressurization target pressure. It is preferable that the target pressure setting section 94 sets a value of 25% or more and less than 80% of the saturated water vapor pressure corresponding to the temperature of the fuel cell stack 30 measured in step S40 as the depressurization target pressure. It is more preferable that the target pressure setting section 94 sets a value of 25% or more and less than 50% of the saturated water vapor pressure corresponding to the temperature of the fuel cell stack 30 measured in step S40 as the depressurization target pressure.

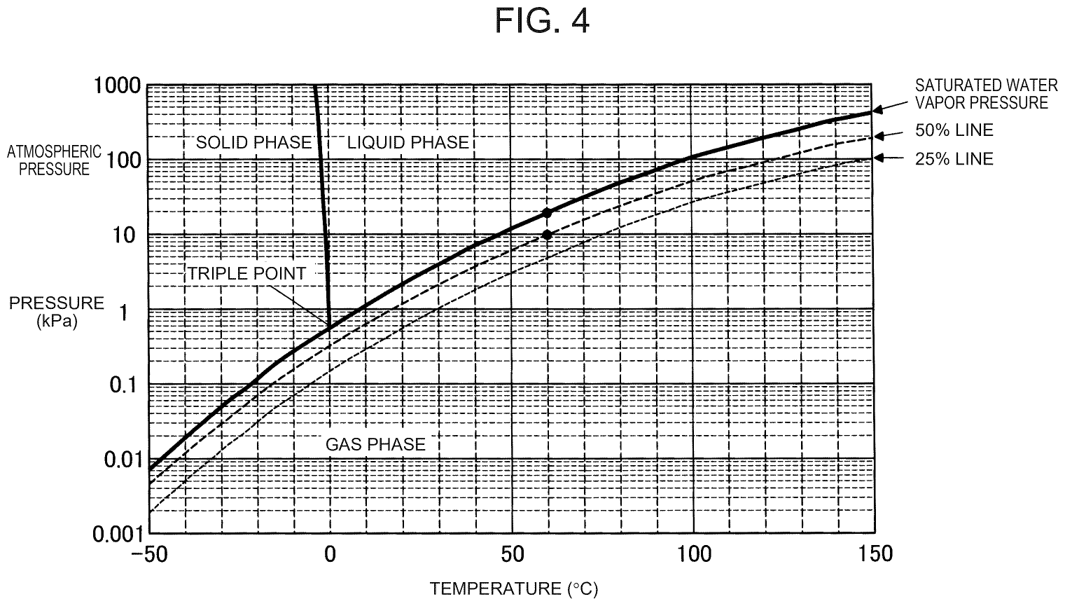

FIG. 4 is a state diagram of water. For example, the saturated water vapor pressure with the fuel cell stack 30 having a temperature of 60° C. is 20 kPa. In a case where the temperature of the fuel cell stack 30 measured in step S40 is 60° C., the target pressure setting section 94 sets the depressurization target pressure, for example, to 10 kPa, which is the pressure corresponding to 50% of the saturated water vapor pressure with the fuel cell stack 30 having a temperature of 60° C.

In step S60 of FIG. 3, the operation control section 93 brings the depressurization section 78 into operation.

In step S70, the operation control section 93 opens the cathode gas branch outlet valve 77. This depressurizes the inside of the cathode gas channel 28 by the depressurization section 78.

In step S80, the operation control section 93 determines whether or not the pressure measured by the pressure measurement section 79 is less than or equal to the depressurization target pressure. In a case where the pressure is less than or equal to the depressurization target pressure, step S90 is executed. In a case where the pressure is not less than or equal to the depressurization target pressure, step S80 is repeated.

In step S90, the operation control section 93 closes the cathode gas branch outlet valve 77.

In step S100, the operation control section 93 brings the depressurization section 78 out of operation. As described above, the operation stop processing is executed.

In a case where the operation control section 93 of the fuel cell system 100 according to the first embodiment described above stops an operation of the fuel cell stack 30, the operation control section 93 controls the depressurization section 78 to cause the depressurization section 78 to depressurize the inside of the cathode gas channel 28 until the pressure of the inside of the cathode gas channel 28 falls below the saturated water vapor pressure corresponding to the temperature of the fuel cell stack 30 measured by the temperature measurement section 40. Depressurizing the inside of the cathode gas channel 28 causes the moisture inside the cathode gas channel 28 to be vaporized and discharged to the outside of the fuel cell stack 30. In addition, it is possible to decrease the amount of moisture included in the membrane electrode assembly 11. The decreased amount of moisture included in the membrane electrode assembly 11 makes an oxidative corrosion reaction of carbon particles supporting a catalyst less likely to occur in the cathode catalyst layer 14 when the fuel cell stack 30 is started next time. The oxidative corrosion reaction is expressed by the following chemical formula (1).

C+2H₂O→CO₂+4H⁺+4e⁻ (1)

The oxidation amount of the carbon particles supporting the catalyst included in the cathode catalyst layer 14 therefore decreases. It is thus possible to reduce the deterioration of the catalyst of the cathode catalyst layer 14 and increase the durability of the fuel cell system 100. The carbon particles supporting a catalyst will be each referred to as catalyst-supporting carbon below.

In addition, in a case where the operation control section 93 stops the operation of the fuel cell stack 30, the operation control section 93 controls the depressurization section 78 to cause the depressurization section 78 to depressurize the inside of the cathode gas channel 28 until the pressure measured by the pressure measurement section 79 reaches the depressurization target pressure in the present embodiment. It is therefore possible to control the operation of depressurizing the cathode gas channel 28 by using the pressure in the cathode gas channel 28 as an indicator.

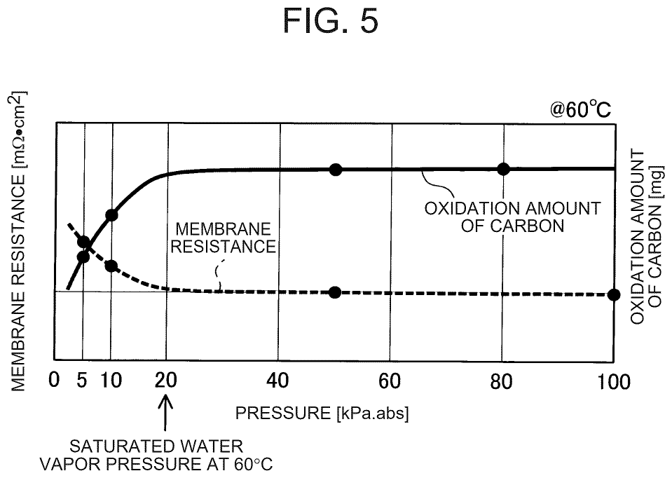

FIG. 5 is a diagram illustrating the relationship between the pressure of the inside of the cathode gas channel 28, the membrane resistance, and the oxidation amount of the catalyst-supporting carbon included in the cathode catalyst layer 14 at the time of the start of the fuel cell stack 30. FIG. 5 illustrates the membrane resistance and the oxidation amount of catalyst-supporting carbon with the fuel cell stack 30 having a temperature of 60° C. As described above, the saturated water vapor pressure with the fuel cell stack 30 having a temperature of 60° C. is 20 kPa. As illustrated in FIG. 5, when the inside of the cathode gas channel 28 is depressurized to pressure lower than the saturated water vapor pressure corresponding to the temperature of the fuel cell stack 30, the amount of moisture included in the membrane electrode assembly 11 decreases. The membrane resistance therefore increases. However, when the membrane electrode assembly 11 is dried and the membrane resistance increases too much, the performance of the fuel cell stack 30 decreases.

In the present embodiment, the target pressure setting section 94 sets a value of 25% or more and less than 80% of the saturated water vapor pressure corresponding to the temperature of the fuel cell stack 30 as the depressurization target pressure. It is therefore possible to decrease the amount of moisture included in the membrane electrode assembly 11 and restrain the membrane electrode assembly 11 from being dried too much.

### B. Second Embodiment

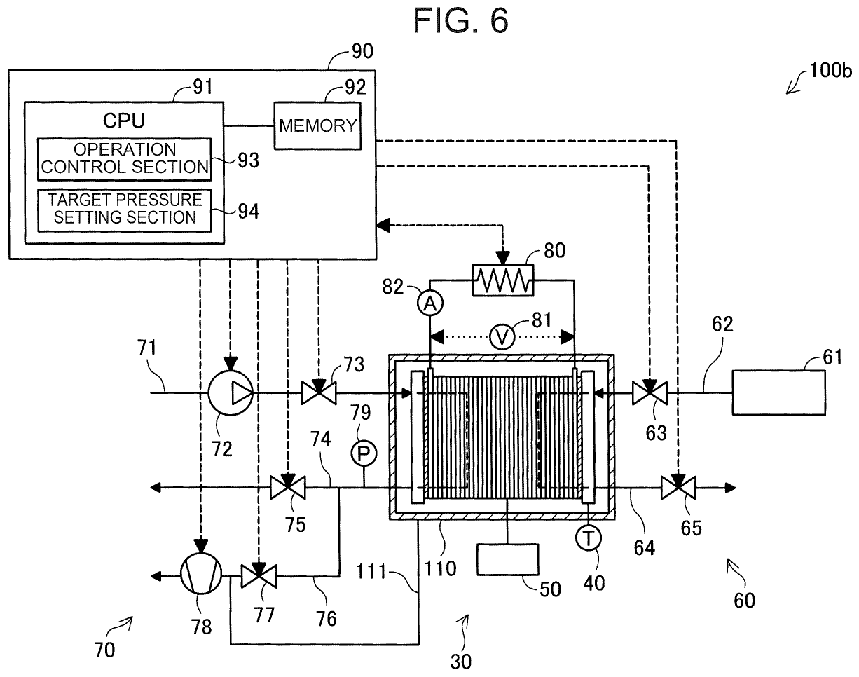

FIG. 6 is an explanatory diagram illustrating a schematic configuration of a fuel cell system 100b according to a second embodiment. The fuel cell system 100b further includes a stack case 110 and a stack case discharge channel 111.

The stack case 110 stores the fuel cell stack 30 therein. The stack case 110 includes a material, such as metal, that allows the inside of the stack case 110 to be depressurized.

The stack case discharge channel 111 is a channel that discharges gas inside the stack case 110. An end of the stack case discharge channel 111 is connected to the stack case 110. The other end of the stack case discharge channel 111 is connected to the cathode gas discharge branch channel 76 between the cathode gas branch outlet valve 77 and the depressurization section 78. That is, the depressurization section 78 is capable of depressurizing the inside of the stack case 110.

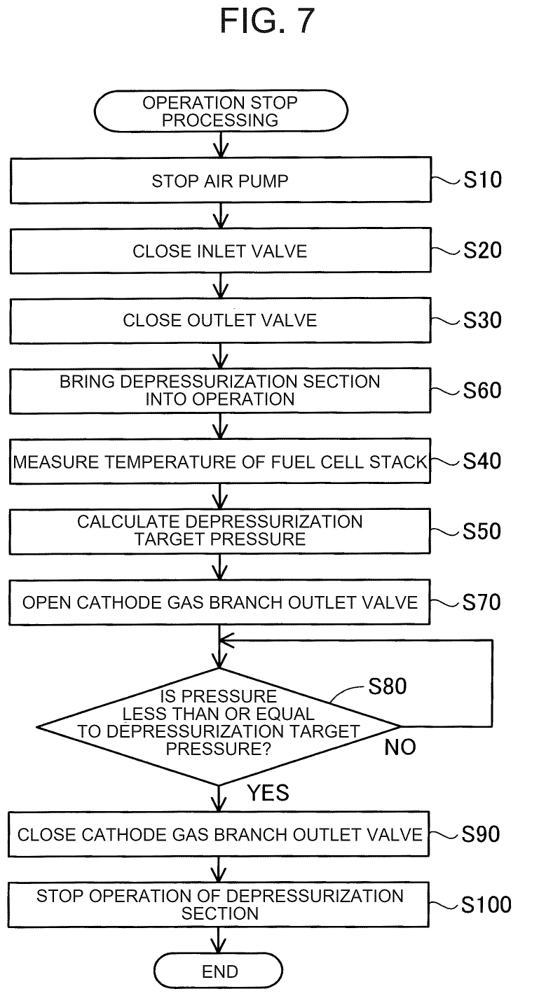

FIG. 7 is a flowchart of operation stop processing according to the second embodiment. In the second embodiment, step S30 to step S70 are executed in the order of step S30, step S60, step S40, step S50, and step S70. In the second embodiment, when the depressurization section 78 is brought into operation in step S60, the inside of the stack case 110 is depressurized.

In a case where the operation control section 93 of the fuel cell system 100b according to the second embodiment described above stops the operation of the fuel cell stack 30, the operation control section 93 controls the depressurization section 78 to cause the depressurization section 78 to depressurize the inside of the stack case 110. It is therefore possible to keep the fuel cell stack 30 warm by insulating the fuel cell stack 30.

The following describes, as an example, a case where the temperature of the fuel cell stack 30 is 60° C. at the time of the execution of step S60 and the target pressure setting section 94 sets the pressure corresponding to 50% of the saturated water vapor pressure corresponding to the temperature of the fuel cell stack 30 measured in step S40 as depressurization target pressure. In the present embodiment, the fuel cell stack 30 is kept warm by executing step S60. In a case where the temperature of the fuel cell stack 30 does not decrease from 60° C., the depressurization target pressure to be set in step S50 is 10 kPa. However, in a case where the fuel cell system 100 does not include the stack case 110, the temperature of the fuel cell stack 30 decreases before the depressurization target pressure is calculated. For example, in a case where the temperature of the fuel cell stack 30 decreases to 40° C., the depressurization target pressure is 4 kPa. The motive power of the depressurization section 78 therefore increases more than the motive power of the depressurization section 78 in a case where the fuel cell stack 30 is kept warm. In the present embodiment, the fuel cell stack 30 is kept warm and it is thus possible to reduce the motive power of the depressurization section 78 and decrease the depressurization section 78 in size. In addition, it is possible to efficiently depressurize the inside of the cathode gas channel 28.

### C. Third Embodiment

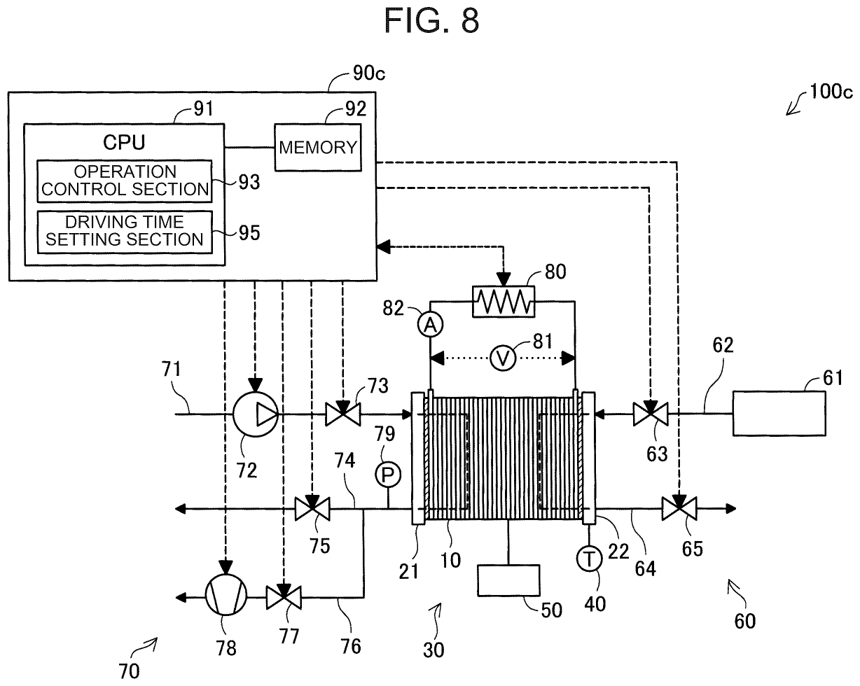

FIG. 8 is an explanatory diagram illustrating a schematic configuration of a fuel cell system 100c according to a third embodiment. A control section 90c of the fuel cell system 100c does not include the target pressure setting section 94 and includes a driving time setting section 95. The configuration of each of the sections of the fuel cell system 100c other than the control section 90c is the same as the configuration of the first embodiment.

The driving time setting section 95 sets the driving time of the depressurization section 78. The driving time setting section 95 is implemented by the CPU 91 reading out and executing a control program stored in the memory 92.

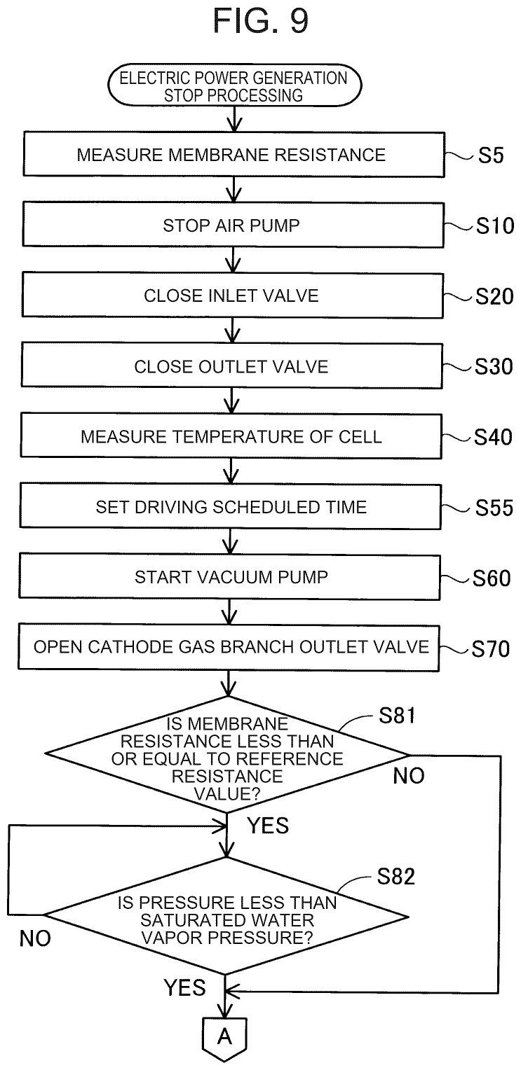

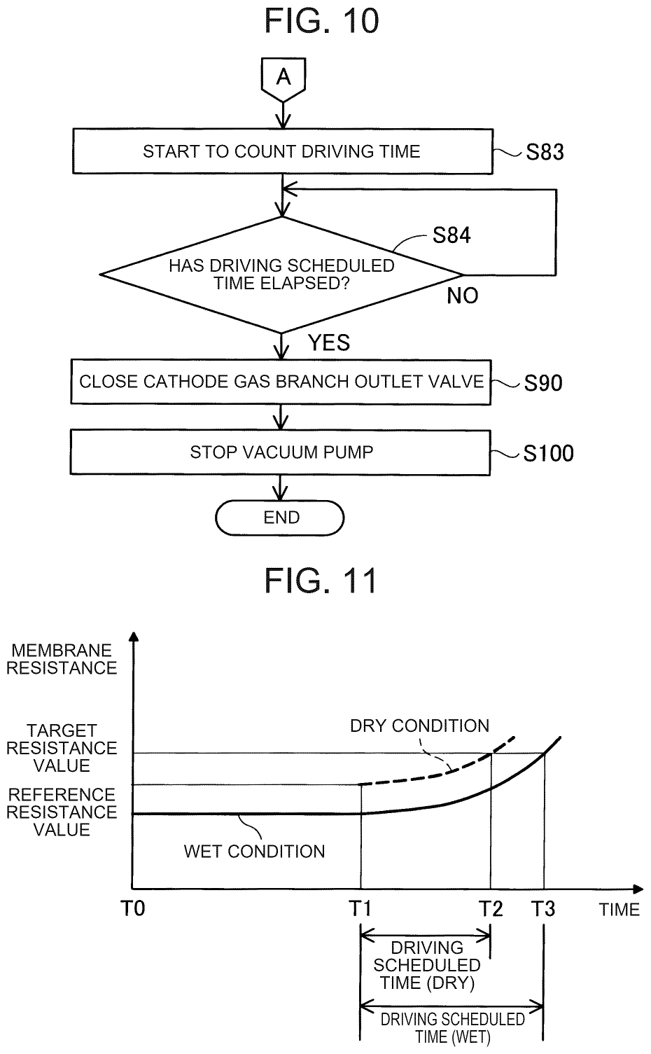

Each of FIG. 9 and FIG. 10 is a flowchart of operation stop processing according to the third embodiment. FIG. 9 and FIG. 10 each denote a step of executing processing similar to processing in FIG. 3 by the same reference sign as the reference sign in FIG. 3 and omit the description.

In step S5, the membrane resistance measurement section 50 measures the membrane resistance.

In step S55, the driving time setting section 95 sets driving scheduled time by using the value of the membrane resistance measured in step S5. The driving scheduled time is the driving time of the depressurization section 78 necessary to increase the value of the membrane resistance to a predefined target resistance value. The target resistance value is a value larger than the value of the membrane resistance in a case where the pressure of the inside of the cathode gas channel 28 is the saturated water vapor pressure corresponding to the temperature of the fuel cell stack 30. It is preferable that the target resistance value is the value of the membrane resistance in a case where the pressure of the inside of the cathode gas channel 28 is 25% or more and less than 80% of the saturated water vapor pressure corresponding to the temperature of the fuel cell stack 30.

FIG. 11 is a diagram describing the driving time of the depressurization section 78 and a change in the membrane resistance. FIG. 11 illustrates a change in the membrane resistance under a wet condition by a solid line and a change in the membrane resistance under a dry condition by a dashed line. The wet condition is a condition that the cathode gas channel 28 has liquid water therein when the anode gas channel 27 and the cathode gas channel 28 are sealed. The dry condition is a condition that the cathode gas channel 28 has no liquid water therein when the anode gas channel 27 and the cathode gas channel 28 are sealed. In other words, the wet condition is a condition that the membrane resistance is less than or equal to a reference resistance value when the anode gas channel 27 and the cathode gas channel 28 are sealed. The dry condition is a condition that the membrane resistance is greater than the reference resistance value when the anode gas channel 27 and the cathode gas channel 28 are sealed. Here, the reference resistance value is the value of the membrane resistance under a condition that the cathode gas channel 28 has liquid water therein, that is, a condition that the electrolyte membrane 12 includes water to the maximum, and a condition that the water vapor pressure of the inside of the cathode gas channel 28 reaches the saturated water vapor pressure corresponding to the temperature of the fuel cell stack 30. It is determined by using the value of the membrane resistance measured in step S5 whether the wet condition or the dry condition is applied. It is to be noted that the saturated water vapor pressure depends on the temperature of the fuel cell stack 30 and the relationship between the driving time of the depressurization section 78 and the membrane resistance thus depends on the temperature of the fuel cell stack 30. FIG. 11 shifts depressurization start time in the case of the dry condition and depressurization start time in the case of the wet condition for the sake of description.

In the case of the dry condition, depressurization is started at time T1 and the membrane resistance reaches the target resistance value at time T2. The driving time setting section 95 sets the time from time T1 to time T2 as driving scheduled time in the case of the dry condition. In the case of the wet condition, depressurization is started at time T0, the pressure of the inside of the cathode gas channel 28 falls below the saturated water vapor pressure at time T1, and the membrane resistance reaches the target resistance value at time T3. The driving time setting section 95 sets the time from time T1 to time T3 as driving scheduled time in the case of the wet condition. It is to be noted that the relationship between the driving time of the depressurization section 78 and a change in the membrane resistance illustrated in FIG. 11 is stored in the memory 92 in advance.

In step S81 of FIG. 9, the operation control section 93 determines whether or not the value of the membrane resistance measured by the membrane resistance measurement section 50 is less than or equal to the reference resistance value. In a case where the membrane resistance is less than or equal to the reference resistance value, step S82 is executed. In a case where the membrane resistance is not less than or equal to the reference resistance value, step S83 is executed. That is, step S82 is executed in the case of the wet condition and step S83 is executed in the case of the dry condition.

In step S82, the operation control section 93 determines whether or not the pressure of the inside of the cathode gas channel 28 measured by the pressure measurement section 79 is less than the saturated water vapor pressure corresponding to the temperature of the fuel cell stack 30 measured by the temperature measurement section 40 in step S40. In a case where the pressure is less than the saturated water vapor pressure, step S83 is executed. In a case where the pressure is not less than the saturated water vapor pressure, step S82 is repeatedly executed. That is, in the case of the wet condition, the inside of the cathode gas channel 28 is depressurized until the pressure of the inside of the cathode gas channel 28 falls below the saturated water vapor pressure.

In step S83, the operation control section 93 starts to count the driving time of the depressurization section 78. In other words, the operation control section 93 counts the time elapsed since it is determined in step S82 that the pressure is less than the saturated water vapor pressure.

In step S84, the operation control section 93 determines whether or not the driving scheduled time has elapsed after it is determined that the pressure is less than the saturated water vapor pressure. In a case where the driving scheduled time has elapsed, step S90 is executed. In a case where the driving scheduled time has not elapsed, step S84 is repeatedly executed.

The driving time setting section 95 of the fuel cell system 100c according to the third embodiment described above sets the driving scheduled time by using the membrane resistance measured by the membrane resistance measurement section 50. In a case where the operation control section 93 stops the operation of the fuel cell stack 30, the operation control section 93 controls the depressurization section 78 to cause the depressurization section 78 to depressurize the inside of the cathode gas channel 28 until the driving scheduled time elapses after the pressure measured by the pressure measurement section 79 falls below the saturated water vapor pressure. It is therefore possible to control the operation of depressurizing the cathode gas channel 28 by using the driving time of the depressurization section 78 as an indicator.

### D. Other Embodiments

(D-1) In the first embodiment and the second embodiment, the fuel cell systems 100, 100b include the membrane resistance measurement sections 50. In contrast, the fuel cell systems 100, 100b do not have to include the membrane resistance measurement sections 50.
(D-2) In the first embodiment, the fuel cell system 100 includes the target pressure setting section 94. In contrast, the fuel cell system 100 does not have to include the target pressure setting section 94. In the case, step S50 of the operation stop processing illustrated in FIG. 3 is not executed. In addition, in step S80, the operation control section 93 determines whether or not the pressure measured by the pressure measurement section 79 is less than the saturated water vapor pressure corresponding to the temperature of the fuel cell stack 30 measured by the temperature measurement section 40. In a case where the pressure is less than the saturated water vapor pressure, step S90 may be executed.

The present disclosure is not limited to the embodiments described above. It is possible to implement the present disclosure in various configurations within the scope that does not depart from the gist of the present disclosure. For example, the technical features in the embodiments corresponding to the technical features in the respective aspects described in the summary of the disclosure can be replaced or combined as appropriate to solve some or all of the problems described above or attain some or all of the effects described above. In addition, the technical features can be deleted as appropriate unless the technical features are described herein as essential.

What is claimed is:

1. A fuel cell system comprising:
a fuel cell stack configured to generate electric power by using a chemical reaction of anode gas and cathode gas;
a temperature measurement section configured to measure temperature of the fuel cell stack;
a depressurization section; and
an operation control section configured to control the fuel cell stack and the depressurization section, wherein
the fuel cell stack includes a cathode gas channel in which the cathode gas flows,
the depressurization section is configured to allow the cathode gas channel to be depressurized, and
the operation control section is configured to, in a case where the operation control section stops an operation of the fuel cell stack, control the depressurization section to cause the depressurization section to depressurize an inside of the cathode gas channel until pressure of the inside of the cathode gas channel falls below saturated water vapor pressure corresponding to the temperature of the fuel cell stack measured by the temperature measurement section.

2. The fuel cell system according to claim 1, comprising:
a pressure measurement section configured to measure the pressure of the inside of the cathode gas channel; and
a target pressure setting section configured to set depressurization target pressure that is the pressure of the inside of the cathode gas channel depressurized by the depressurization section, wherein
the target pressure setting section is configured to set the pressure less than the saturated water vapor pressure as the depressurization target pressure, and
the operation control section is configured to, in the case where the operation control section stops the operation of the fuel cell stack, control the depressurization section to cause the depressurization section to depressurize the inside of the cathode gas channel until the pressure measured by the pressure measurement section reaches the depressurization target pressure.

3. The fuel cell system according to claim 2, wherein the target pressure setting section is configured to set, as the depressurization target pressure, a value of 25% or more of the saturated water vapor pressure and less than 80% of the saturated water vapor pressure.

4. The fuel cell system according to claim 1, further comprising a stack case in which the fuel cell stack is stored, wherein:
the depressurization section is configured to allow an inside of the stack case to be depressurized; and
the operation control section is configured to, in the case where the operation control section stops the operation of the fuel cell stack, control the depressurization section to cause the depressurization section to depressurize the inside of the stack case.

5. The fuel cell system according to claim 1, comprising:
a pressure measurement section configured to measure the pressure of the inside of the cathode gas channel;
a membrane resistance measurement section configured to measure membrane resistance that is electric resistance of a membrane electrode assembly included in the fuel cell stack; and
a driving time setting section configured to set driving time of the depressurization section, wherein
the driving time setting section is configured to set driving scheduled time by using the membrane resistance measured by the membrane resistance measurement section, the driving scheduled time being the driving time necessary to increase a value of the membrane resistance to a predefined target resistance value, and
the operation control section is configured to, in the case where the operation control section stops the operation of the fuel cell stack, control the depressurization section to cause the depressurization section to depressurize the inside of the cathode gas channel until the driving scheduled time elapses after the pressure measured by the pressure measurement section falls below the saturated water vapor pressure.
